(19) United States
(12) Patent Application Publication
(10) Pub. No.: US 2010/0060569 A1
(43) Pub. Date: Mar. 11, 2010

(54) WIRELESS REMOTE CONTROL HAVING MOTION-BASED CONTROL FUNCTIONS AND METHOD OF MANUFACTURE THEREOF

(75) Inventor: John H. Shamilian, Tinton Falls, NJ (US)

Correspondence Address: HITT GAINES, PC;ALCATEL-LUCENT, PO BOX 832570, RICHARDSON, TX, 75083, US

(73) Assignee: Lucent Technologies Inc., Murray Hill, NJ (US)

(21) Appl. No.: 12/207,421

(22) Filed: Sep. 9, 2008

(51) Int. Cl. G09G 5/00

(52) U.S. Cl. 345/156

(57) ABSTRACT

A wireless remote control and a method of manufacturing the same. In one embodiment, the wireless remote control includes: (1) a body, (2) an orientation detector located in the body, (3) a processor located in the body and coupled to the orientation detector and configured to receive an orientation signal from the orientation detector, (4) a memory located in the body and coupled to the processor and containing software configured to cause the processor to generate a media playback control signal based on the orientation signal and (5) wireless communication circuitry located in the body and coupled to the processor and configured to receive and wirelessly transmit the media playback control signal.

### TECHNICAL FIELD OF THE INVENTION

The invention is directed, in general, to remote controls and, more specifically, to a wireless remote control having motion-based control functions and a method of manufacturing the same.

### BACKGROUND OF THE INVENTION

Remote-controllable electronic devices, particularly wireless remote-controllable consumer electronics, can be found in many businesses and virtually every home in the modern world. The average home tends to have many such devices. Television sets, videocassette recorders (VCRs), digital versatile disc (DVD) players and recorders, laserdisc players, personal video recorders (PVRs) or digital video recorders (DVRs), cable television and satellite receivers, audio receivers, compact disc (CD) players and recorders, cassette tape players and recorders, Motion Picture Experts Group (MPEG)-1 Audio Layer 3 or 4 (MP3 or MP4) players, and audio and video switches and distribution systems are just some of many varieties of remote-controllable electronic devices found today. Future devices will no doubt abound.

Conventional wireless remote controls for these devices feature an array of buttons that allow a user to invoke functions of the devices from a distance. These functions may include changing channels, adjusting volumes, selecting modes of operation, and controlling the manner in which a device plays streaming media, such as audio media (e.g., music or a speech) or audiovisual media (e.g., movies, television shows or advertisements). By means of these buttons and perhaps a dial, a user may cause media to be played, paused, stopped, cued, fast-forwarded, rewound, skipped forward, skipped back or shuttled. Shuttling is a recognized term for playing media at various, user-adjustable speeds and directions.

### SUMMARY OF THE INVENTION

One aspect of the invention provides a wireless remote control. In one embodiment, the wireless remote control includes: (1) a body, (2) an orientation detector located in the body, (3) a processor located in the body and coupled to the orientation detector and configured to receive an orientation signal from the orientation detector, (4) a memory located in the body and coupled to the processor and containing software configured to cause the processor to generate a media playback control signal based on the orientation signal and (5) wireless communication circuitry located in the body and coupled to the processor and configured to receive and wirelessly transmit the media playback control signal.

Another aspect of the invention provides a method of manufacturing a wireless remote control. In one embodiment, the method includes: (1) forming a body, (2) placing an orientation detector in the body, (3) placing a processor in the body, the processor configured to receive an orientation signal from the orientation detector, (4) placing a memory in the body, the memory containing software configured to cause the processor to generate a media playback control signal based on the orientation signal and (5) placing wireless communication circuitry in the body, the wireless communication circuitry configured to receive and wirelessly transmit the media playback control signal.

Yet another aspect of the invention provides a computer-readable storage medium containing software configured to cause a wireless communication device to generate a media playback control signal based on an orientation signal received from an orientation detector thereof.

### BRIEF DESCRIPTION OF THE DRAWINGS

For a more complete understanding of the invention, reference is now made to the following descriptions taken in conjunction with the accompanying drawings, in which:

FIG. 1 illustrates a plan view of one embodiment of a wireless remote control constructed according to the principles of the invention along with various examples of electronic devices that the wireless remote control may be employed to control;

FIGS. 2A, 2B and 2C respectively illustrate plan, lower-side and right-side views of one embodiment of a wireless remote control constructed according to the principles of the invention;

FIGS. 3A and 3B illustrate further embodiments of a wireless remote control constructed according to the principles of the invention; and

FIG. 4 illustrates a flow diagram of one embodiment of a method of manufacturing a wireless remote control carried out according to the principles of the invention.

### DETAILED DESCRIPTION

As stated above, conventional wireless remote controls feature an array of buttons that allow a user to invoke functions of the devices from a distance. These functions may include controlling the manner in which a device plays streaming media, including shuttling. By means of these buttons, or perhaps a dial, a user may cause media to be shuttled. As those skilled in the pertinent art understand, shuttling is a recognized term for playing media at various, user-adjustable speeds and directions (e.g., forward or reverse) and is useful, for example, in finding or analyzing specific portions of media.

Conventional shuttling may be performed in one of two ways. Less precise shuttling may be performed with several buttons. Each press of one button adds forward velocity to the shuttle speed. Each press of another button adds reverse velocity to the shuttle speed. An optional third button pauses. In this way, shuttle speed can be incremented or decremented through a series of discrete forward and reverse speed steps. More precise shuttling may be performed with a dial. The dial has a central, pause position. Turning the dial clockwise shuttles forward proportional to the amount by which the dial is turned. Turning the dial counterclockwise shuttles in reverse proportional to the amount by which the dial is turned. Some dials are spring-loaded such that they return to their central, pause position when released.

Disclosed herein is a novel way to perform shuttling or invoke other remote control functions that involves detecting the orientation of the remote control using an orientation detector such as one or more angular position sensors or accelerometers. A user may then reposition or reorient the remote control itself rather than manipulate buttons or a dial. In some embodiments to be illustrated and described, conventional wireless devices, such as smartphones and personal digital assistants (PDAs), already equipped with an orientation detector are augmented with software (defined for purposes of this description as including firmware) to yield a novel remote control. In some embodiments, an optical relay conveys commands from the software-enhanced wireless devices to optical sensors of conventional electronic devices. In still other embodiments, an optical bridge is provided, or one or more electronic devices are modified, to recognize direct input from a conventional wireless device, such as a game controller, that is already equipped with an orientation detector. In yet other embodiments, otherwise conventional remote control designs are modified to include an orientation detector and appropriate hardware or software to yield a novel remote control.

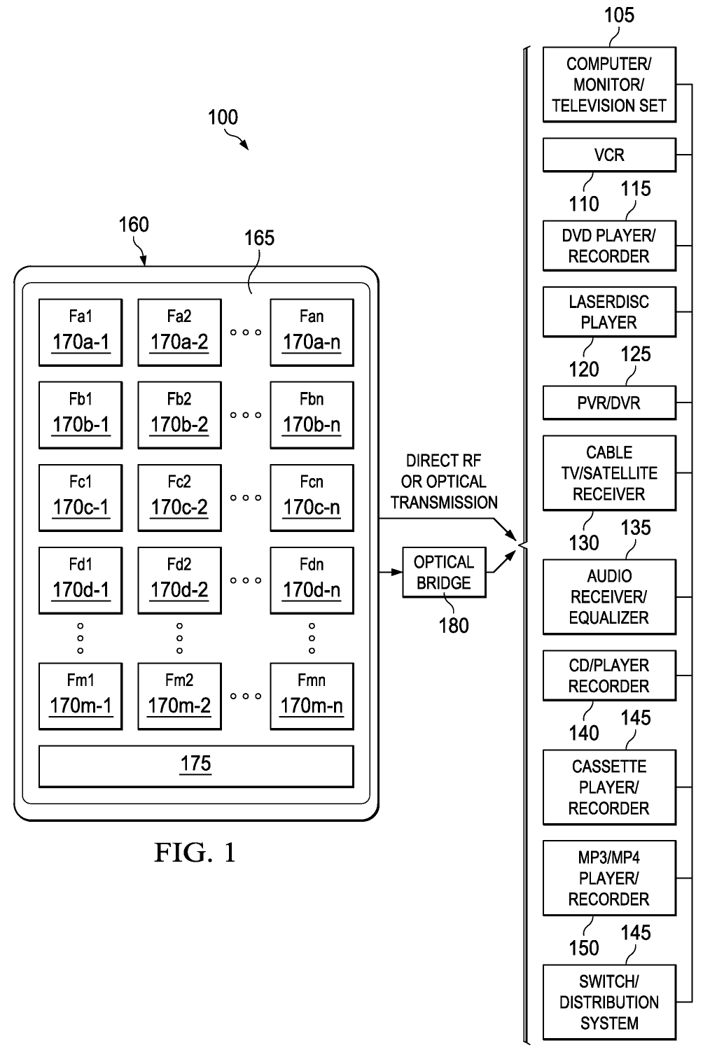

FIG. 1 illustrates a plan view of one embodiment of a wireless remote control 100 constructed according to the principles of the invention along with various examples of electronic devices that the wireless remote control 100 may be employed to control. While FIG. 1 shows various examples of electronic devices, the examples shown are not all-inclusive. The novel wireless remote control 100 described herein may be employed to control any electronic device that is or may be made remote controllable.

The electronic devices include a computer/monitor/television set 105, which may be a personal computer (PC) or any other type of conventional or later-developed computer, a conventional or later-developed monitor for such computer or a conventional or later-developed television (TV) set. The computer/monitor/television set 105 is assumed to be capable at the least of displaying an image, including a video image, and may also be capable of reproducing sound through its own speakers or external speakers, which qualifies it to play audiovisual media. If the computer/monitor/television set 105 is a computer, it may be capable of decoding and playing audio media contained in one or more MP3 or MP4 files, decoding and playing audiovisual media contained in one or more QuickTime®, Audio Video Interleave (AVI) or MPEG audiovisual formats, and also encoding audio or audiovisual media and creating one or more MP3/MP4, QuickTime®, AVI, or MPEG files.

The electronic devices include a VCR 110. The VCR 110 is capable of playing audiovisual media stored on a videotape using the computer/monitor/television set 105 and perhaps also recording audiovisual data on a videotape and may be of any conventional or later-developed type or format.

The electronic devices include a DVD player/recorder 115. The DVD player/recorder 115 is capable of playing audiovisual media stored on a DVD using the computer/monitor/television set 105 and perhaps also recording audiovisual data on a DVD and may be of any conventional or later-developed type or format.

The electronic devices include a laserdisc player 120. The laserdisc player 120 is capable of playing audiovisual media stored on a laserdisc using the computer/monitor/television set 105 and may be of any conventional or later-developed type or format.

The electronic devices include a PVR/DVR 125. The PVR/DVR 125 is capable of playing audiovisual media, typically from a hard disk drive, using the computer/monitor/television set 105, storing audiovisual media on the hard disk drive and perhaps also recording audiovisual data on a DVD and may be of any conventional or later-developed type or format.

The electronic devices include a cable TV/satellite receiver 130. The cable TV/satellite receiver 130, which may also be known as a “set-top box,” is capable of converting cable TV or satellite signals into audiovisual media and playing the audiovisual media using the computer/monitor/television set 105 and may be of any conventional or later-developed type or format.

The electronic devices include an audio receiver 135. The audio receiver/equalizer 135 is capable of playing audio media using one or more speakers (not shown) originating from various sources and may include an equalizer to tailor frequencies at which the audio media is played back. The audio receiver 135 may be of the “home theater” type, in which case it is further capable of playing audiovisual media using the computer/monitor/television set 105 originating from various sources, e.g., the VCR 110, the DVD player/recorder 115, the laserdisc player 120, the PVR/DVR 125 and the cable TV satellite receiver 130.

The electronic devices include a CD player/recorder 140. The CD player/recorder 140 is capable of playing audio media stored on a CD, perhaps using the audio receiver 135, and perhaps also recording audio data on a CD and may be of any conventional or later-developed type or format.

The electronic devices include an audiocassette player/recorder 145. The audiocassette player/recorder 145 is capable of playing audio media stored on an audiocassette, perhaps using the audio receiver 135, and also recording audio data on an audiocassette and may be of any conventional or later-developed type or format.

The electronic devices include an MP3/MP4 player/recorder 150. The MP3/MP4 player/recorder 150 is capable of decoding and playing audio media contained in one or more MP3 or MP4 files, perhaps using the audio receiver 135, and also encoding audio media and creating one or more MP3/MP4 files. The player/recorder 150 may, however, reproduce and/or record audio media in any other conventional or later-developed format.

The electronic devices include a switch/distribution system 155. The switch/distribution system 155 may couple one or more sources of audio or audiovisual media to one or more destinations therefor. The switch/distribution system 155 may, for example, allow so-called “whole house” distribution over a given premises.

In one embodiment, the aforementioned electronic devices are conventionally provided with optical sensors, allowing them to receive optical (e.g., infrared) control signals. In another embodiment, the aforementioned electronic devices are capable of receiving radio-frequency (RF) control signals.

FIG. 1 illustrates one embodiment of a wireless remote control 100. The wireless remote control 100 includes a body 160 having a touch-sensitive display screen 165 coupled thereto and extending over most of a major surface thereof. The display screen 165 is configured to display an image and receive input from a user in the form of pressure applied to one or more portions of the display screen 165. A processor (not shown) located in the body 160 and coupled to the display screen 165 correlates the one or more portions with the image displayed on the display screen 165 to determine the location (e.g., one or more X-Y coordinates), nature (e.g., press or slide) and consequence (i.e., function to be invoked) based on the user input.

With specific reference to FIG. 1, the display screen 165 displays an image that includes an m-by-n array of “soft” buttons 170a-1, . . . , 170m-n, m and n being any pair of integer numbers, that span different portions of the display screen 165 as shown. Functions Fa1, . . . , Fmn correspond with the buttons 170a-1, . . . , 170m-n. If, for example, a user presses the portion of the display screen 165 corresponding to the location of the button 170c-2, the processor makes the correlation and executes the function Fc2 in response thereto, generating a control signal. The display screen 165 further includes a slide control 175y. The slide control 175 defines a portion of the display screen 165 in which pressure applied in a sliding manner across the slide control 175 invokes a corresponding function, e.g., changing volume or color level. In alternative embodiments, the buttons 170a-1, . . . , 170m-n and the slide control 175 take on a variety of shapes and sizes and are not arranged as FIG. 1 shows. The display screen 165 can display any image containing any number or arrangement of buttons or slide controls whatsoever.

In one embodiment, the image resembles a conventional multi-function or “universal” remote control in which the “soft” buttons include an on/off button, a numeric keypad, channel up/down buttons, volume up/down buttons or a slide control, mode and source selection buttons and media control buttons, including stop, pause, fast-forward and rewind buttons.

However, unlike a conventional remote control, the wireless remote control 100 can interpret changes in the orientation of its body 160 as control commands, including commands to control the manner in which an electronic device plays streaming media. These media control commands may include shuttling. Various embodiments of this will be explained below.

One embodiment of the wireless remote control 100 of FIG. 1 employs as its hardware platform a conventional wireless device, such as a smartphone or PDA, equipped with an orientation detector. Such smartphones or PDAs currently include, e.g., the iphone®, iphone® 3G or iPod® Touch commercially available from Apple Incorporated of Cupertino, Calif., the HTC Touch Diamond™ commercially available from High Tech Computer Corporation of Taiwan, the N82™ or N95™ commercially available from Nokia Corporation of Espoo, Finland, or the W910i commercially available from Sony Ericsson of Lund, Sweden. The wireless device is augmented with software to yield the wireless remote control 100. In an alternative embodiment, the wireless remote control 100 employs a later-developed wireless device as its hardware platform and augments that wireless device with software to yield the wireless remote control 100. As those skilled in the pertinent art are familiar, these and other conventional smartphones and PDAs employ RF to communicate wirelessly under one or more of Bluetooth (governed by the Bluetooth Special Interest Group), WLAN (a set of wireless local area network standards governed by IEEE 802.11), GSM (Global System for Mobile Communications), EDGE (Enhanced Data rates for GSM Evolution) or UMTS (Universal Mobile Telecommunications System). Some smartphones and PDAs employ other standards, including optical wireless communication standards, in lieu of or in addition to these.

As stated above, in one embodiment, the aforementioned electronic devices 105-155 are conventionally provided with optical sensors, allowing them to receive wireless control signals transmitted via (e.g., infrared) light. FIG. 1 shows an optical bridge 180. The optical bridge 180 has an RF receiver configured to receive RF wireless control signals from the wireless remote control 100, bridging hardware (perhaps including software) coupled to the RF receiver and configured to convert or translate the RF wireless control signals into optical form and an optical transmitter coupled to the bridging hardware and configured to transmit the optical wireless control signals to the electronic devices 105-155. In another embodiment, the aforementioned electronic devices 105-155 are capable of receiving RF wireless control signals. In this embodiment, the optical bridge 180 is not needed; the wireless remote control 100 can transmit them via RF directly to the electronic devices 105-155 as shown. In yet another embodiment, the wireless remote control 100 is provided with a wireless optical transmitter (not shown). The optical bridge 180 is not needed in this embodiment either; the wireless remote control 100 can transmit optical wireless control signals directly to the electronic devices 105-155 as shown.

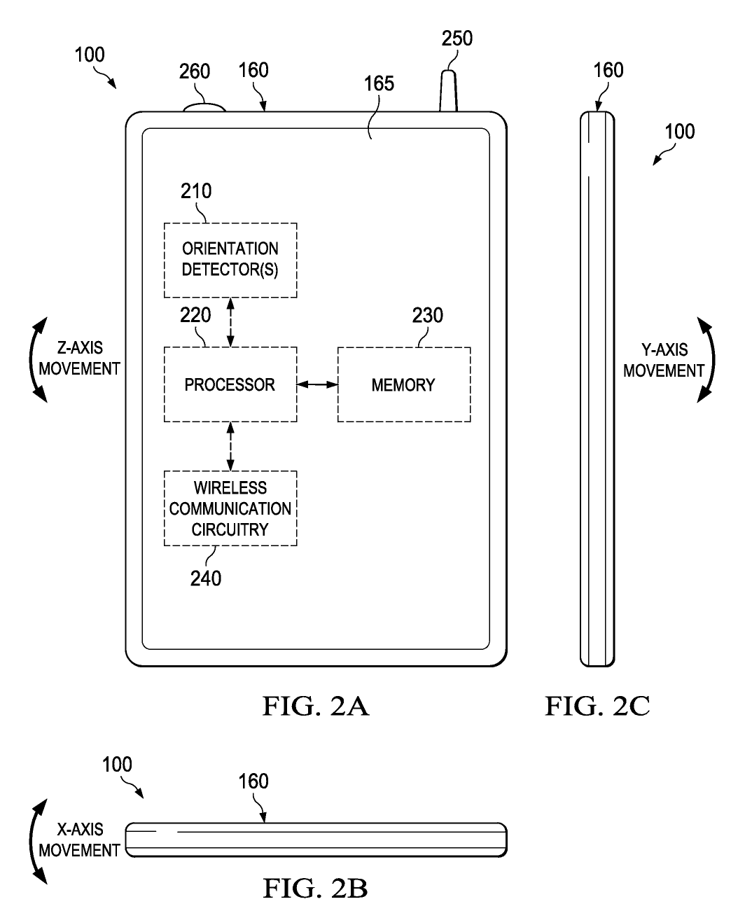

FIGS. 2A, 2B and 2C respectively illustrate plan, lower-side and right-side views of one embodiment of a wireless remote control 100 constructed according to the principles of the invention. The wireless remote control 100 includes a body 160. The body 160 may be of any size or shape whatsoever.

The wireless remote control 100 further includes an orientation detector 210. The orientation detector 210 is located in the body 160. The orientation detector 210 is configured to produce an orientation signal based on the orientation of the body 160. The orientation detector 210 may be an angular position sensor, an accelerometer or any other detector that would indicate a translation, vibration or rotation of the body 160. Suitable accelerometers are commercially available from Analog Devices Incorporated of Cambridge, Mass.; however, the invention is not limited to a brand or type of orientation detector. The orientation detector 210 may be a one-, two- or three-axis detector. In the embodiment of FIGS. 2A-C, the orientation detector 210 is a three-axis detector. Accordingly, FIG. 2A shows a Z-axis rotation that the orientation detector 210 can detect. FIGS. 2B and 2C show respective X- and Y-axis movements (e.g., translations, rotations or vibrations) that the orientation detector 210 can likewise detect. Other embodiments employ X-, Y- or Z-axes that are oriented differently with respect to the body 160; the invention is not limited to particular axes or numbers of axes.

The wireless remote control 100 further includes a processor 220. The processor 220 is located in the body 160. The processor 220 is configured to receive an orientation signal from the orientation detector 210. The processor 220 may be of any type, speed or capability whatsoever.

The wireless remote control 100 further includes a memory 230 located in the body 160 and coupled to the processor 220. The memory 230 contains software configured to cause the processor 220 to generate a media playback control signal based on the orientation signal. The body 160 may be of any type, capacity or speed whatsoever. As stated above, certain embodiments employ a conventional wireless device that is augmented with software to yield a wireless remote control. In one embodiment, the manufacturer of the conventional wireless device loads the software into the memory 230. In another embodiment, the memory 230 includes writeable memory into which the software is loaded following a transfer of custody of the device to a user. Thus, the user can load the software into a conventional wireless device to yield a wireless remote control.

In the embodiment of FIGS. 2A-C, an X-axis rotation of the body 160 causes the orientation detector 210 to generate a corresponding orientation signal, which the processor 220 interprets as being a media playback command, and specifically a shuttle command. In response, the processor 220 generates a corresponding media playback control signal, specifically a playback shuttle control signal that, in the illustrated embodiment, causes audio or audiovisual media to be shuttled in a direction and at a speed that is proportionate to the direction (i.e., clockwise or counterclockwise) and extent (i.e., number of degrees) to which the body 160 is rotated about its X-axis.

In one embodiment, media playback commands are context-sensitive. For example, if the body 160 rotates about an axis when media is not being played, the rotation is ignored. As another example, if the body 160 rotates while a particular electronic device (e.g., the computer/monitor/television set 105 of FIG. 1) is in a particular mode (e.g., a video settings mode), the rotation may be interpreted as a specific command having nothing to do with media playback, e.g., sharpness adjustment). As yet another example, if media is being played, rotation of the body 160 may be interpreted as selecting different media (e.g., a previous or subsequent song), and a media playback control signal is generated. As still another example, if media being played is paused (e.g., by pressing a button on the wireless remote control 100), subsequent rotation of the body 160 may then be interpreted as indicating a desire on the part of the user to shuttle the media, and a playback shuttle control signal are generated.

In one embodiment, the processor 220 takes the speed at which the body 160 is translated, rotated or vibrated into account in forming its commands. For example, rapid motion may give rise to gross commands, e.g., large changes in shuttle speed. Slower motion may therefore give rise to finer commands, perhaps allowing a user to shuttle or perform other functions more efficiently.

The wireless remote control 100 further includes wireless communication circuitry 240 located in the body 160 and coupled to the processor 220. The wireless communication circuitry 240 is configured to receive and wirelessly transmit the media playback control signal. In one embodiment, the wireless communication circuitry 240 transmits the media playback control signal as an RF signal via an antenna. An internal antenna (not shown) or an external antenna 250 may be used for this purpose. Alternatively or additionally, the wireless communication circuitry 240 transmits the media playback control signal as an optical signal via a light-emitting component 260, such as a light-emitting diode (LED).

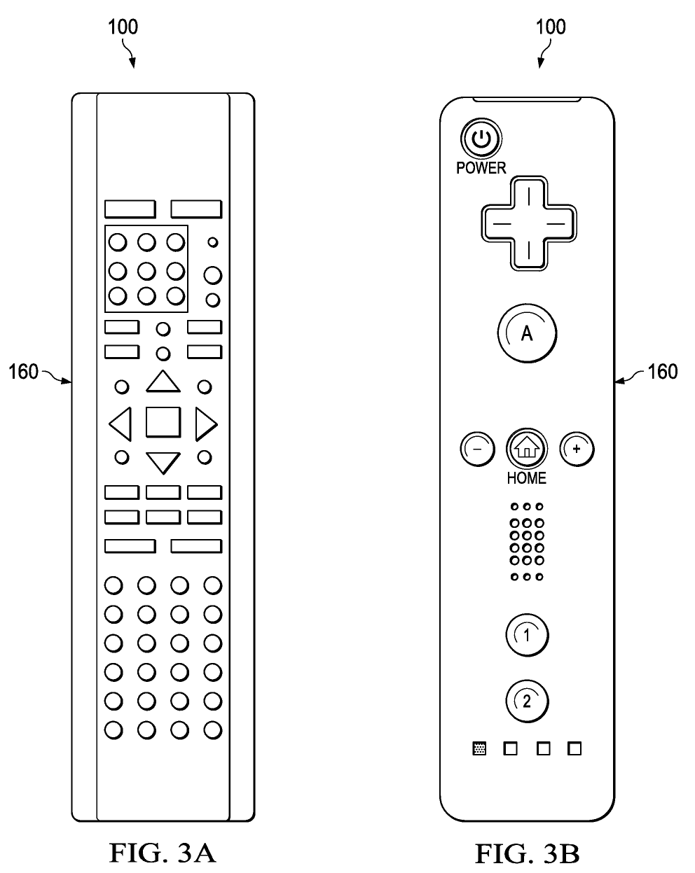

FIGS. 3A and 3B illustrate further embodiments of a wireless remote control constructed according to the principles of the invention. FIG. 3A shows one embodiment of the wireless remote control 100 that takes the form of a conventional or later-developed multi-function or “universal” remote control in which unreferenced physical (not “soft”) buttons include an on/off button, a numeric keypad, channel up/down buttons, volume up/down buttons, mode and source selection buttons and media control buttons, including stop, pause, fast-forward and rewind buttons. However, the wireless remote control 100 is not convention. Though FIG. 3A does not illustrate it, the wireless remote control 100 contains one or more orientation detectors and hardware or software configured to receive an orientation signal from the one or more orientation detectors and cause a media playback control signal based on the orientation signal to be generated. Wireless communication circuitry coupled to the processor may then transmit RF, or more likely optical signals conveying the media playback control signal to one or more electronic devices as appropriate. If the wireless remote control 100 contains software, it may also include a writeable memory into which the software is loaded during manufacture of the universal remote control 100. In an alternative embodiment, the wireless remote control 100 is not multi-function or “universal;” rather it is specific to a specific electronic device (such as a particular model of TV set) or multiple specific electronic devices (such as only one manufacturer's electronic devices).

FIG. 3B shows one embodiment of the wireless remote control 100 that takes the form of a conventional or later-developed game controller, such as a Wii® Remote commercially available from Nintendo Company Ltd. of Kyoto, Japan, that is already equipped with one or more orientation detectors. In this embodiment, the wireless remote control 100 includes the optical bridge 180 of FIG. 1 or hardware or software in an electronic device that converts an orientation or other signal produced by the game controller into a control signal suitable for performing various functions with respect the electronic device, including a media playback control signal that can control various media playback functions, including shuttling.

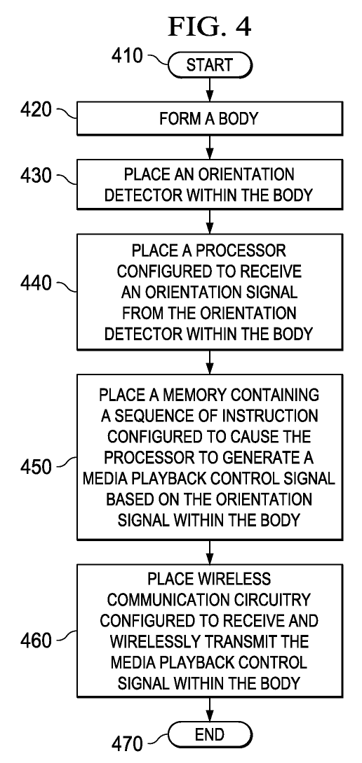

FIG. 4 illustrates a flow diagram of one embodiment of a method of manufacturing a wireless remote control carried out according to the principles of the invention. The method begins in a start step 410. A body is formed in a step 420. In a step 430, an orientation detector is placed in the body. In a step 440, a processor is placed in the body and coupled to the orientation detector. The processor is configured to receive an orientation signal from the orientation detector. In a step 450, a memory is placed in the body and coupled to the processor. The memory may or may not be integrated with the processor. The memory is configured to contain software configured to cause the processor to generate a media playback control signal based on the orientation signal. Thus, the software may be loaded into the memory during manufacture, or the memory may be writable, allowing the software to be loaded after manufacturing. In a step 460, wireless communication circuitry is placed in the body and coupled to the processor. The wireless communication circuitry is configured to receive and wirelessly transmit the media playback control signal. That wireless transmission may RF, optical or both RF and optical. The method ends in an end step 470.

Certain embodiments of the invention further relate to computer storage products with a computer-readable medium that have program code thereon for performing various computer-implemented operations that embody the tools or carry out the steps of the methods set forth herein, specifically to cause a wireless communication device to generate a media playback control signal based on an orientation signal received from an orientation detector thereof. The media and program code may be those specially designed and constructed for the purposes of the invention, or they may be of the kind well known and available to those having skill in the software arts. Examples of computer-readable media include, but are not limited to: magnetic media such as hard disks, floppy disks, and magnetic tape; optical media such as CD-ROM disks; magneto-optical media such as floptical disks; and hardware devices that are specially configured to store and execute program code, such as ROM and RAM devices. Examples of program code include both machine code, such as produced by a compiler, and files containing higher level code that may be executed by the computer using an interpreter.

Those skilled in the art to which the invention relates will appreciate that other and further additions, deletions, substitutions and modifications may be made to the described embodiments without departing from the scope of the invention.

What is claimed is:

1. A wireless remote control, comprising:
a body;
an orientation detector coupled to said body;
a processor located in said body and coupled to said orientation detector and configured to receive an orientation signal from said orientation detector;
a memory located in said body and coupled to said processor and containing software configured to cause said processor to generate a media playback control signal based on said orientation signal; and
wireless communication circuitry located in said body and coupled to said processor and configured to receive and wirelessly transmit said media playback control signal.

2. The wireless remote control as recited in claim 1 wherein said orientation detector comprises:
an angular position sensor, and
an accelerometer.

3. The wireless remote control as recited in claim 1 wherein said media playback control signal comprises a playback shuttle control signal.

4. The wireless remote control as recited in claim 1 wherein said media is selected from the group consisting of:
audio media, and
audiovisual media.

5. The wireless remote control as recited in claim 1 wherein said wireless communication circuitry comprises a transceiver selected from the group consisting of:
a Bluetooth transceiver, and
a wireless local area network transceiver.

6. The wireless remote control as recited in claim 1 further comprising a button-based input device, said memory further configured to contain software configured to cause said processor to generate an electronic device control signal other than said media playback control signal based on a signal received from said button-based input device.

7. The wireless remote control as recited in claim 1 wherein said body, said orientation sensor, said processor, said memory and said wireless communication sensor are part of a device selected from the group consisting of:
a smartphone,
a personal digital assistant, and
a game controller, and
said memory includes writeable memory into which said software is loaded following a transfer of custody of said device to a user.

8. The wireless remote control as recited in claim 1 wherein said wireless remote control is a universal remote control and said memory includes writeable memory into which said software is loaded during manufacture of said universal remote control.

9. The wireless remote control as recited in claim 1 wherein said wireless remote control is configured to provide remote playback control to at least one electronic device selected from the group consisting of:
a videocassette recorder,
a digital versatile disc player,
a personal video recorder,
a digital video recorder,
a compact disc player, and
a cassette tape player.

10. The wireless remote control as recited in claim 9 wherein said wireless remote control is specific to said at least one electronic device.

11. A method of manufacturing a wireless remote control, comprising:
forming a body;
placing an orientation detector in said body;
placing a processor in said body, said processor configured to receive an orientation signal from said orientation detector;
placing a memory in said body, said memory containing software configured to cause said processor to generate a media playback control signal based on said orientation signal; and
placing wireless communication circuitry in said body, said wireless communication circuitry configured to receive and wirelessly transmit said media playback control signal.

12. The method as recited in claim 11 wherein said orientation detector comprises:
an angular position sensor, and
an accelerometer.

13. The method as recited in claim 11 wherein said media playback control signal comprises a playback shuttle control signal.

14. The method as recited in claim 11 wherein said media is selected from the group consisting of:
audio media, and
audiovisual media.

15. The method as recited in claim 11 wherein said wireless communication circuitry comprises a transceiver selected from the group consisting of:
a Bluetooth transceiver, and
a wireless local area network transceiver.

16. The method as recited in claim 11 further comprising coupling a button-based input device to said body, said memory further configured to contain software configured to cause said processor to generate an electronic device control signal other than said media playback control signal based on a signal received from said button-based input device.

17. The method as recited in claim 11 wherein said wireless remote control is a universal remote control and said memory includes writeable memory, said method further comprising loading said software into said memory.

18. The method as recited in claim 11 wherein said wireless remote control is configured to provide remote playback control to at least one electronic device selected from the group consisting of:
a videocassette recorder,
a digital versatile disc player,
a personal video recorder,
a digital video recorder,
a compact disc player, and
a cassette tape player.

19. The method as recited in claim 18 wherein said wireless remote control is specific to said at least one electronic device.

20. A computer-readable storage medium containing software configured to cause a wireless communication device to generate a media playback control signal based on an orientation signal received from an orientation detector thereof.
